(19) United States
(12) Patent Application Publication
(10) Pub. No.: US 2026/0025275 A1
(43) Pub. Date: Jan. 22, 2026

(54) SYSTEMS AND METHODS FOR AUTOMATED ENCRYPTED COMMUNICATION BETWEEN CENTRALIZED COMPUTING SYSTEMS

(71) Applicant: Propractice Solutions, West Jordan, UT (US)

(72) Inventors: Shane Billings, Atlanta, GA (US); Brad Billings, Syracuse, UT (US)

(21) Appl. No.: 19/270,190

(22) Filed: Jul. 15, 2025

Related U.S. Application Data
(60) Provisional application No. 63/673,122, filed on Jul. 18, 2024.

(51) Int. Cl. H04L 9/32; H04L 9/06

(52) U.S. Cl. CPC H04L 9/3228; H04L 9/0631; H04L 9/3236

(57) ABSTRACT

A method for secure authentication and encrypted message delivery is disclosed. The method includes receiving login information from a user, the login information comprising a password and a time-sensitive email-based security code. The password is verified using a cryptographic hash function, and the code is validated using a time-limited JSON Web Token (JWT). Upon successful authentication, a user request for messages is received and used to retrieve messages from a database. The messages are serialized and encrypted using AES-256 encryption, with encryption keys retrieved at runtime from a secure key management service. The encrypted data objects are encoded and transmitted to the user over a secure transport channel. The method supports multi-factor authentication, brute-force protection, session freshness validation, and role-based access control. Encrypted session persistence tokens may also be stored via secure cookies. The system enables end-to-end secure handling of sensitive data, such as protected health information.

### CROSS-REFERENCE TO RELATED APPLICATION

This application claims the benefit of U.S. Provisional Application No. 63/673,122, filed on Jul. 18, 2024, and entitled “SYSTEMS AND METHODS FOR AUTOMATED ENCRYPTED COMMUNICATION BETWEEN CENTRALIZED COMPUTING SYSTEMS”, the entirety of which is hereby incorporated by reference herein.

### BACKGROUND

The present relates generally to secure communication systems and, more specifically, to systems and methods for secure, structured, and auditable communication between medical billing teams and insurance providers in connection with insurance claims.

In the medical billing industry, communication inefficiencies between providers and insurance companies frequently lead to delays, denials, and revenue losses. Conventional systems focus on claim submission and billing but lack structured communication workflows, robust security enforcement, and integrated audit trails for claim-related interactions.

Moreover, existing platforms fail to ensure that communication involving Protected Health Information (PHI) and financial data is adequately secured in accordance with HIPAA regulations. Traditional tools rely on disjointed methods—emails, notes, spreadsheets, calls—that are neither secure nor trackable.

In light of these shortcomings, further improvements in systems and methods of communication are desired.

### SUMMARY

The present disclosure relates generally to secure data processing systems and, more particularly, to systems and methods for authenticating users, retrieving protected data, and securely transmitting encrypted message content.

In one embodiment, a method is provided for securely processing user login and encrypted message delivery. The method includes receiving login information from a user, the login information comprising at least a password and a time-sensitive email-based security code. The password is verified using a cryptographic hash function, such as bcrypt, and the email-based security code is validated using a time-limited JSON Web Token (JWT). In certain embodiments, the time-limited token is issued at login and signed using a secret key retrieved dynamically at runtime from a secure key management service, such as Amazon Web Services (AWS) Secrets Manager.

The method further comprises receiving, from an authenticated user, a request for one or more messages, the request comprising information relating to the user. Such information may include a username, password, unique token, or location-related information such as an IP address or MAC address. The system retrieves the requested messages from a database, serializes the messages into a structured format (e.g., JSON), and encrypts the serialized data using AES-256 encryption. The encryption key is retrieved at runtime from a secure key management service and is not embedded in the application codebase.

In some embodiments, the encrypted data is encoded as a Base64 string and transmitted

to the requesting user over a secure communication channel, such as HTTPS. User session freshness may be validated by comparing activity timestamps stored in a database and denying access when a session is determined to be stale.

Additional security mechanisms may include multi-factor authentication (MFA), persistent login using secure, device-bound cookies (e.g., httpOnly, secure, sameSite), and brute-force protection via login throttling based on a tiered lockout strategy. The system may further enforce role-based access control (RBAC) by populating a user context with authenticated attributes such as organization identifier, office identifier, and permission group to ensure least-privilege access policies.

Accordingly, embodiments of the disclosed invention provide for a secure, scalable, and policy-driven approach to user authentication, data access, and encrypted message delivery, suitable for deployment in compliance-sensitive environments such as those governed by the Health Insurance Portability and Accountability Act (HIPAA).

### BRIEF DESCRIPTION OF THE FIGURES

The accompanying drawings, which are incorporated in and constitute a part of the specification, illustrate exemplary embodiments of the invention and, together with the description, serve to explain the principles of the invention. In the drawings:

FIG. 1 is a block diagram illustrating an example system architecture for secure authentication, data retrieval, and encrypted message delivery.

FIG. 2 is a flow diagram illustrating an example process for receiving and validating user login information using a password and time-sensitive email-based security code.

FIG. 3 is a flow diagram illustrating an example authentication process using multi-factor authentication and time-limited JSON Web Tokens (JWTs).

FIG. 4 is a flow diagram illustrating an example encryption process, including serialization of data and runtime key retrieval from a secure key management service.

FIG. 5 is a flow diagram illustrating an example information request workflow between authenticated users across organizational teams, including secure commentary and approval mechanisms.

FIG. 6 is a flow diagram illustrating an example of a process for processing Insurance Verifications.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

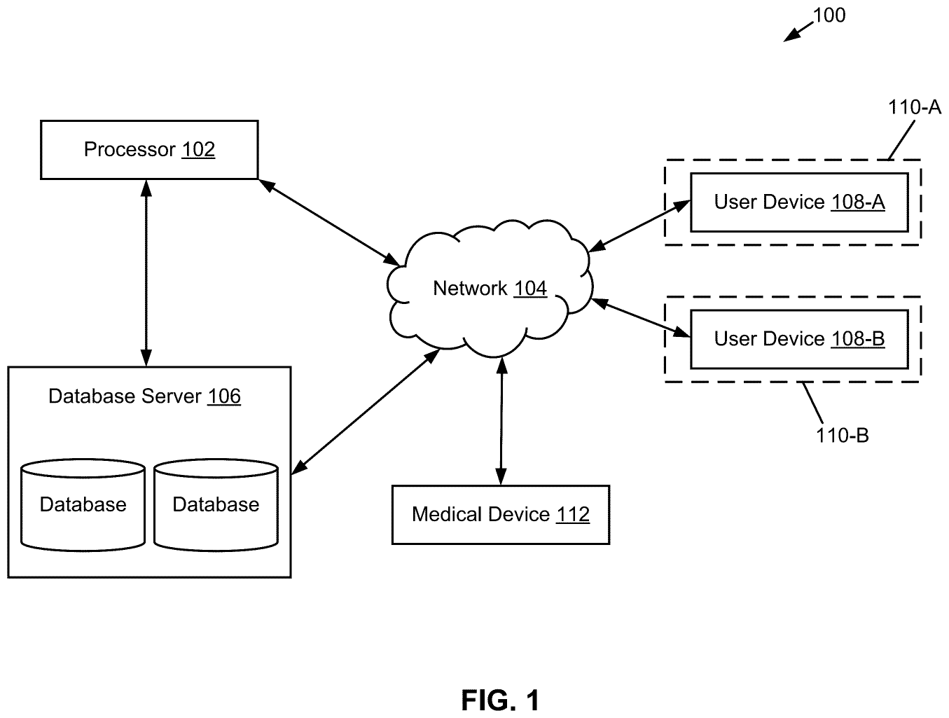

With reference now to FIG. 1, a schematic depiction of one embodiment of a system 100 for secure information communication is shown. The system 100 can comprise one or more computing components 102, which can include one or more processors, computers, servers, computer chips, integrated circuits, CPUs, GPUs, and/or the like. In some embodiments, the one or more computing components 102 can include one or more physical computing components and/or one or more virtual computing components. In some embodiments, for example, the one or more computing components 102 can comprise one or several compute instances, some or all of which can comprise a physical server or a virtual machine running on one or several host machines.

In some embodiments, and in contrast to traditional platforms that store claim-related messages in unencrypted or locally stored files, the system 100 encrypts and stores information such as, for example, protected health information and/or financial data in cloud buffer storage. In some embodiments, the storage can be encrypted utilizing AES-256. In some embodiments, this encryption can provide data security at rest and in transit. In some embodiments, documents and messages can be decrypted when retrieved by an authorized user, and access logs can track interaction, and in some embodiments, all interactions for auditing purposes.

In some embodiments, the system 100 can utilize event-driven communications with real-time auditing. In some embodiments, the system can employ event-driven logging, which automatically timestamps all message interactions, creating an immutable audit trail. In some embodiments, logs can include: identification of who sent, viewed, or modified a message and when; a record of all responses and escalations in the claim inquiry process; and/or automated notifications for outstanding messages that require attention.

The one or more computing components 102 can be configured to perform one or several operations. These one or several operations can be performed based on information received from, for example, one or more user devices and/or medical equipment, and/or can be performed based on computer readable stored instructions executed by the one or more computing components 102.

The one or more computing components 102 can comprise one or more servers, which can comprise any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. The one or more servers can include one or more server farms, clusters, or any other appropriate arrangement and/or combination or computer servers. In some embodiments, the one or more servers can act according to stored instructions located in a memory subsystem of the server, and can run an operating system, including any commercially available server operating system and/or any other operating systems discussed herein.

The one or more computing components 102 can be communicatively coupled either directly or indirectly vie a communications network 104 to memory 106. The memory 106, can comprise, for example, one or more database servers. In some embodiments, the database server can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server, and particularly, the tier 0 storage is the fastest storage that is not RAM or cache memory. In some embodiments, the tier 0 memory can be embodied in solid state memory such as, for example, a solid-state drive (SSD) and/or flash memory.

In some embodiments, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some embodiments, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives (e.g., Serial AT Attachment drives) or one or several NL-SATA drives.

In some embodiments, the one or several hardware and/or software components of the database server can be arranged into one or several storage area networks (SAN), which one or several storage area networks can be one or several dedicated networks that provide access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

Data stores may comprise stored data relevant to the functions of the content network. In some embodiments, multiple data stores may reside on a single server, either using the same storage components of server or using different physical storage components to assure data security and integrity between data stores. In other embodiments, each data store may have a separate dedicated data store server.

The system 100 can include one or more networks 104, which can be configured to facilitate communication between modules and/or components of the system 100. These networks 104 can include one or more wired and/or wireless networks. In some embodiments, the one or more networks 104 can include one or more Local Area Networks, one or more Wide Area Networks, and/or the like. In some embodiments, the one or more networks can include one or more intranets, the internet, and/or the like.

The system 100 can include one or more user devices 108. The one or more user

devices 108 can include any computing device such as a personal computer, a laptop, a tablet, a smartphone, a smartwatch, or the like via which the user can provide inputs to the system 100 and can receive outputs from the system 100. In some embodiments, the system 100 can include a first user device 108-A located at a first location 110-A, a second user device 1-8-B located at a second location 110-B, and any other desired number of user devices 108 located at any desired number of locations 110.

The system 100 can include one or more medical devices 112. In some embodiments, the medical devices 112 can each comprise one or more sources of medical information relevant to a patient which information can be aggregated by system and/or can be stored in the database server 106. In some embodiments, the one or more medical devices 112 can include, for example, one or more imaging devices, measuring devices, listening devices, treatment devices, and/or the like.

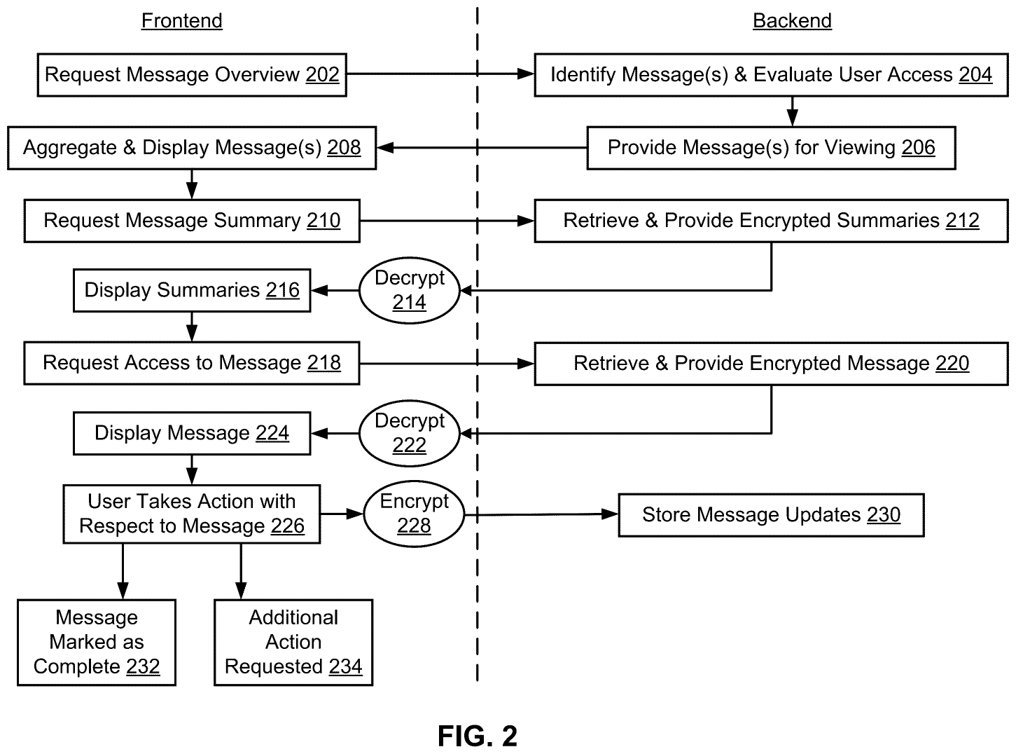

In some embodiments, the system 100 can be configured to process messages and/or attach documents to the messages. In some embodiments, the system can support messages including, for example, one or more information requests and/or one or more insurance verification messages. In some embodiments an information request can be a message requesting clarification and/or additional details related to a claim. In some embodiments, an insurance verification message can include a message used for verifying insurance coverage and/or claim details. In some embodiments, processing the message can include frontend and backend processing of the message. FIG. 2 is a swimlane flowchart illustrating one embodiment of a process 200 for processing messages.

The process 200 begins at block 202, wherein the frontend, and specifically a user device 108 in the frontend requests viewing and/or an overview of one or more messages. In some embodiments, this can include a user logging in to the user device 108 and/or to the system 100. In some embodiments, the user logging in to the device 108 and/or system 100 can include the user providing information as discussed in detail below under heading “Authentication.” As also discussed under that heading, the system 100 can process the login information and can authenticate the user. This request can be transmitted, for example by the network 104 to the backend, which can identify the messages and evaluate the user access to the messages as indicated in block 204.

In some embodiments, for example, the request for the messages can include information relating to the user. This information can, identify the user including, for example, providing a username and password, a token, and/or the like. In some embodiments, this information can further include information relating to the user's device and/or location. This can include, for example, an IP address, a MAC address, a user location, or the like.

In some embodiments, the backend can determine user access based on this information. This can include, evaluating the information to determine the identity of the user and, based on the user identity, determining an access level for the user. In some embodiments, the backend can further determine a user location and can determine an access level based on the user location and/or office. In some embodiments, user access can be determined based on the union of access provided by the user identity and the user location. In such an embodiment, the user can have access when they have an allowed identity and are in an allowed location.

At block 206, the backend can provide the requested messages for viewing when it has been determined that the user is allowed access to those messages, and at block 208, the messages can be aggregated and displayed to the user by the frontend.

At block 210, the frontend, and specifically the user device 108 can request one or more message summaries and/or message details. In some embodiments, this can include the frontend sending a request to the backend for the one or more message summaries and/or message details. In some embodiments, the user originating the request can have an account with one or more permissions and/or one or more specific functional allowances. In some embodiments, Multi-factor authentication (MFA) can ensure that the user is authenticated utilizing a one-time passcode (OTP). In some embodiments, MFA can be periodically enforced to ensure account integrity.

For HIPAA purposes, the user has restricted visibility to only the data they can query in the database based on assigned office and their role. To be assigned to an office, a user can be selected for an office by a user with admin privileges. Patient information can be assigned to offices and is only visible to users assigned to the office. Thus, in some embodiments, the system 100 can utilize both Role-Based Access Control (RBAC) and Office-Based security. In some embodiments, the Office-Based Access Control (OBAC) can provide a geographic and/or organizational level to the security by only providing access to users at a certain physical location and/or only to user associated with an office or entity.

At block 212, the request is received by the backend. The backend can then evaluate the user credentials, and if the user has the required permissions, the backend can retrieve and/or generate the requested summaries, and encrypt and provide the requested summaries to the user.

At block 214, the frontend can receive the encrypted summaries, and can decrypt the summaries. At block 216, the summaries can be displayed to the user by the frontend, and specifically by the user device 108.

At block 218, the frontend requests access to one or more messages. In some embodiments, this can include the frontend sending a request to the backend for the one or more messages.

At block 220, the backend can receive the request for access to the messages, and can evaluate the user credentials, and if the user has the required permissions, the backend can retrieve and/or generate the requested message, and encrypt and provide the requested messages to the user.

In some embodiments, this can include querying for patient data in the database server 106, and specifically in a non-relational document database (NRDB) for patients in a specific office(s) or single patient information.

In some embodiments, retrieving the messages can include de-identifying the retrieved messages and/or data associated with the retrieved messages. In some embodiments, this can include identifying PII in the data based on header and information type. Relevant patient data, including PII, can be retrieved and appropriate portions of the data can be decrypted according to AES-256. Relevant data can be identified in the header. Documents can be retrieved and decrypted from cloud buffer storage by the backend.

At block 222, the frontend can receive the encrypted messages, and can decrypt the messages. At block 224, the messages can be displayed to the user by the frontend, and specifically by the user device 108.

At block 226 the user takes some action with respect to one or more of the messages via the user device 108. In some embodiments, this action can include, for example, revising a message, adding a comment to a message, and/or marking a message as complete. The frontend can transmit one or more packets to the backend identifying and/or comprising the message updates. In some embodiments, and as indicated at 228, these one or more packets can be encrypted by the frontend and can be provided encrypted to the backend. In some embodiments, the backend can decrypt these one or more packets and can store the message updates as indicated in 230.

In the event that the user action with request to the message comprises marking the message as complete, the message can be marked as complete in a graphical user interface displayed on the user device 108 as indicated in block 232. In some embodiments, this can include removing the updated message from the list and/or display of message for which an action is required; adding the message to a list and/or display of messages that are complete and/or for which no further action is required; and/or adding an indicator to the message indicating that the message is completed.

In the event that the user action with request to the message comprises marking the message as needing an additional action, the message can be marked as needing an additional action in a graphical user interface displayed on the user device 108 as indicated in block 234. In some embodiments, this can include adding the message to a list of actions for which an additional action is requested; adding an indicator to the message indicating that a further action is requested in association with the message; and/or the like.

### Authentication

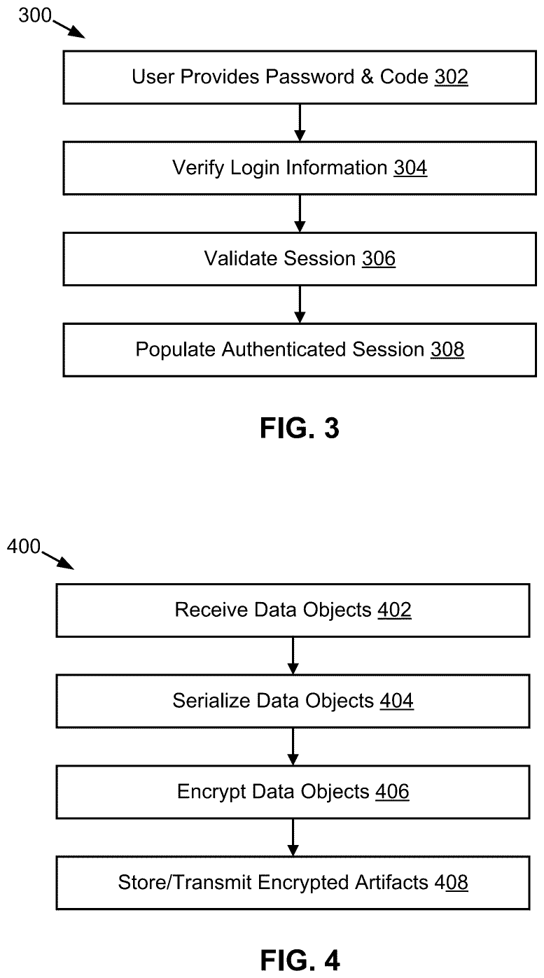

In some embodiments, the system 100 can utilize a unique authentication method to control access to information in the system. This can include, for example, authenticating users through a secure multi-factor authentication (MFA) process combined with session-based JSON Web Token (JWT) management. One embodiment of this authentication process 300 is depicted in FIG. 3.

At step 302, a user provides a password and a six-digit email-based security code during login. In some embodiments, a time-limited token is issued by the backend, and specifically by the backend server such as processor 102. This information can be received by the frontend and is provided to the backend for authentication or alternatively, the frontend can perform the authentication. At step 304, the login information, and specifically the password is verified. In some embodiments, this can be verified via bcrypt. In some embodiments, the email-based security code can be validated against the time-limited token issued at login.

In some embodiments, the time-limited token can comprise a JWT token. The JWT token can, in some embodiments, be signed using a dynamic secret key that can be retrieved at runtime by the backend. In some embodiments, the dynamic secret key can be retrieved by the backend server such as processor 102 from a secure key manager such as, for example Amazon Web Services (AWS) Secrets Manager. In some embodiments, these JWT tokens are not hardcoded or stored in application code, thereby supporting secure key management and enabling seamless key rotation.

In some embodiments, each of the JWT tokens can be time limited, and in some embodiments, can be configured to expire within 24 hours. Each of the JWT tokens can be validated using one or more hash functions such as, for example, SHA-256, HMAC-SHA256, and/or the like.

In some embodiments, each token can be passed via the authorization header. In some such embodiments, each token can have their signature verified by the backend (server-side) before allowing access. This token-based structure ensures scalable session control, minimizes long-term credential exposure, and enforces stateless authentication across all protected endpoints.

At block 306, user sessions are validated against activity timestamps stored in the database. In some embodiments, this validation can be performed by the backend. If the session is stale, access is denied. In some embodiments, a session can be identified as stale when a predetermined amount of time without any user activity has passed. In some embodiments, a session can be stale when 30 minutes has passed without user activity. In some embodiments, when a session is stale, a logout is forced. On each successful request, the user's activity timestamp can be updated, enforcing a session freshness policy. Timestamps can be recorded using Mongoose's automatic timestamps: true schema option, or via direct calls to new Date( ) in request lifecycle operations. These timestamps can be stored in ISO 8601 format in MongoDB and are immutable after creation.

At step 308, the authenticated user context can be populated via Mongoose with nested fields including organizationId, permissionGroup, and officeId, along with office-level adminId. Permissions can be enforced through role-based access control (RBAC) and can be further scoped by office assignment to enforce least-privilege policies.

In some embodiments, the system 100 can also include brute-force protection and progressive login delay enforcement. In such an embodiment, login attempts are throttled using a multi-step lockout strategy: After 3 failed attempts, users must wait 10 minutes; after 5 failed attempts, the delay increases to 40 minutes; and after 6+failed attempts, logins are disabled for at least 60 minutes. These rules can be enforced based on a timestamp of the last failed login attempt and incrementing counters tracked in the database (loginAttempt, failedAttempt, lastLogin).

On successful authentication, optional session persistence can be enabled using encrypted device-bound cookies, stored as httpOnly, secure, and sameSite tokens. Cookies store encrypted machine identifiers that are matched with previously stored device fingerprints in the database (Machine model). All persistent login data can be encrypted using AES-256, with encryption keys also managed via AWS Secrets Manager.

In some embodiments, and in addition to API-based access restrictions, the system 100 can implement custom socket-level authentication and message authorization]. When a socket connection is initiated, the client includes a signed payload containing authentication and context data. This payload is verified server-side before any subscription or data exchange occurs. Unauthorized users are explicitly rejected before room/channel assignment or message handling can proceed. This layer ensures that only authenticated users with valid JWT tokens and proper office/team association can establish or interact with real-time communication channels, preserving the same strict access boundaries enforced by the REST API. This prevents cross-office message interception or unauthorized socket traffic in live environments.

In some embodiments, socket connections can be open to any subscribed client without any security application. To ensure security of information passed through the system 100, information is added to each socket data packet. This information forces rejection of the packet if the client isn't authenticated. Thus, the data is not shared unless the user is verified.

In some embodiments of the system, all protected API routes are guarded by middleware that enforces authentication, token validity, role-based permissions, and office-level access scoping before any controller or business logic is executed. This prevents unauthorized users from accessing even internal logic, regardless of how requests are crafted. Middleware validation occurs using JWTs and populated user context (e.g., organizationId, officeId, permissionGroup) retrieved via Mongoose, enforcing least-privilege access by design.

### Encryption

In some embodiment, the system 100 implements robust data protection for all claim-related information through symmetric encryption utilizing the Advanced Encryption Standard (AES), specifically AES-256. In some embodiments, all messages, documents, and protected health information are encrypted using AES-256 both at rest and in transit. In some embodiments, the system 100 can enforce Multi-Factor Authentication (MFA) with One-Time Passcodes (OTP) to prevent unauthorized access. One embodiment of a process 400 for encryption is shown in FIG. 4.

Encryption operations can be performed via the CryptoJS cryptographic library, enabling secure encoding of sensitive data elements including, but not limited to, insurance verification records, patient information, information request data, user-generated comments, workflow state history, and audit trail metadata. As indicated in step 402, one or more data objects are received for encryption. As shown in block 404, and prior to encryption, structured data objects are serialized into a platform-agnostic format, such as JavaScript Object Notation (JSON), to ensure consistency and interoperability.

At step 406, the data objects are encrypted. Encrypted output is encoded as Base64 strings for transmission and storage compatibility. Encryption keys are not embedded within the application logic; instead, they are retrieved at runtime from a secure key management service, such as AWS Secrets Manager, via an internal secrets access utility. This ensures secure key isolation and eliminates key persistence within the codebase or runtime memory beyond immediate use.

Each encryption transaction is associated with an environment-specific context key, such as an ENC_KEY or AES_SECRET_KEY, also retrieved from AWS Secrets Manager. In certain use cases, the encryption context is further specialized by incorporating a user-specific identifier, such as a user ID (e.g., req.user._id), to generate user-bound encrypted payloads, thereby facilitating fine-grained access control.

As indicated in step 408, encrypted artifacts can be stored within a document-based NoSQL datastore or transmitted to clients via secure HTTPS channels. Decryption operations are initiated only upon verified access requests, such as authenticated frontend sessions or authorized internal service calls. Decryption employs the same key retrieval process to ensure consistency with the encryption context and is executed with comprehensive logging and error handling to maintain access traceability and operational fault tolerance.

The described system architecture and methods facilitate end-to-end encryption of sensitive data, including Protected Health Information (PHI) and financial records, in a manner compliant with data protection frameworks such as the Health Insurance Portability and Accountability Act (HIPAA). Secure encryption is applied during all phases of the data lifecycle—at rest, in transit, and during authorized processing—thereby ensuring a high level of data confidentiality and integrity.

### Information Request Workflow

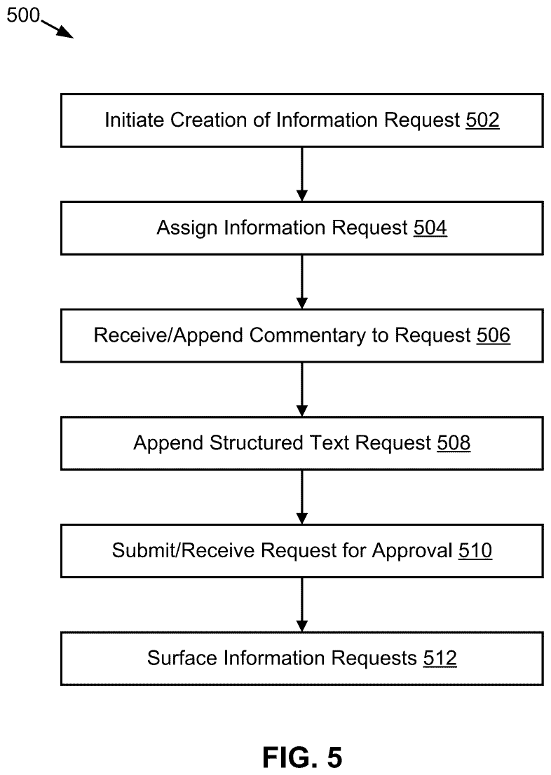

In one embodiment, the system provides a structured, auditable workflow for handling Information Requests between users affiliated with different operational teams. One embodiment of this is depicted as process 500 in FIG. 5.

At step 502, a first user initiates the creation of a new Information Request through the user interface. During the creation process, the user inputs structured data fields including, but not limited to, patient identification, associated medical office identifier, financial amount, appointment date, insurance provider, and any user-generated classification tags intended for downstream reporting or analytics. In some embodiments, and as a part of step 502, the system 100 can receive the new information request from the user.

At step 504, and upon submission, the system programmatically assigns the Information Request to a secondary (i.e., non-originating) team, hereafter referred to as the alternate team. The Information Request becomes available to any team member within the alternate team, provided that the member is also assigned access to the originating medical office. Access control is enforced based on role-based permissions linked to both team and office identifiers.

At step 506, any authorized user affiliated with the originating medical office may append commentary to the Information Request, which commentary can be received by the system 100. Insertion of comments does not affect the existing team assignment. All comment entries are persisted in an immutable audit log with associated timestamps, which are captured using system-generated time signals and stored in a tamper-evident format.

At step 508, a team member associated with the currently assigned team may initiate an information escalation protocol by appending a structured text request for additional information. In some embodiments, the structured text request can be received by the system 100 and can be appended to the request by the system 100. The system then reassigns the Information Request to the alternate team and logs the informational request. Upon reassignment, the alternate team is notified and enabled to respond by submitting supplemental information and reassigning the request back to the requesting team.

At step 510, the receiving team may indicate task completion by submitting the Information Request for approval. In some embodiments, the system 100 can receive the information request for approval. This action includes a validation message and results in the reassignment of the Information Request to the alternate team. The system marks the request with a “pending approval” status.

At step 512, Information Requests in a “pending approval” state are programmatically surfaced to the appropriate team. Upon approval and final submission, the Information Request is transitioned to a terminal “complete” state. The completed record is removed from active workflow queues and persisted in a separate datastore designated for completed requests.

In some embodiments, all completed Information Requests remain queryable via a secure audit interface for compliance, reporting, or retrospective analysis. In some embodiments, the system permits reactivation of completed Information Requests. Upon reactivation, the request is reintroduced into the workflow as if newly created, maintaining linkage to the original audit history. In some embodiments, the system enforces audit integrity through a non-reversible data model. Communication logs, including comment threads and timestamp metadata, are write-once and read-many. No user or service is permitted to overwrite or delete audit history, ensuring compliance with industry regulatory standards such as HIPAA.

### Insurance Verification Workflow

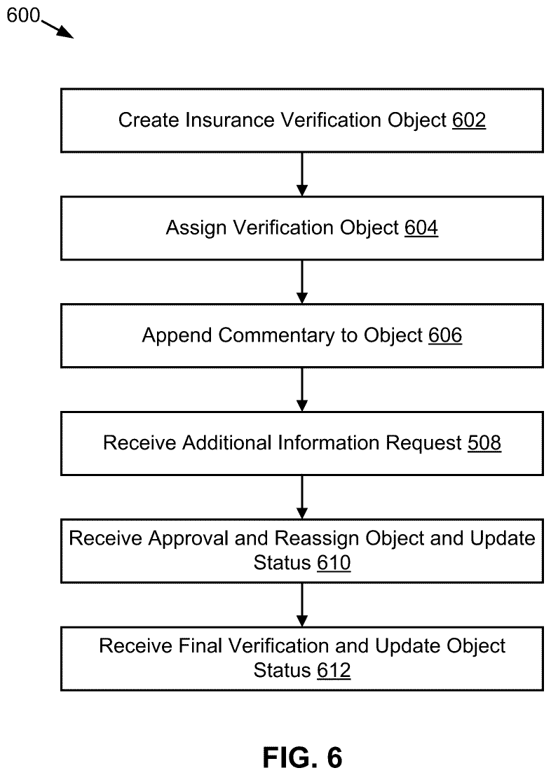

In one embodiment depicted in FIG. 6, the system 100 provides a secure, auditable process 600 for processing Insurance Verifications, wherein data is created, routed, and validated through interactions between users affiliated with distinct operational teams. The process 600 ensures that medical, financial, and administrative data related to insurance validation are handled in a traceable and access-controlled manner.

At step 602, an Office Team user initiates the creation of an Insurance Verification object by supplying a defined set of structured fields. This request can be initiated by interaction with the system 100, which system 100 can, in some embodiments, create the insurance verification object. These fields include patient identifier (e.g., name), medical office identifier, monetary value associated with the verification, scheduled appointment date, insurance provider name, patient date of birth, and patient-specific insurance details. This data can be validated against predefined schema constraints and serialized for persistence.

At step 604, and in some embodiments upon successful instantiation, the system 100 programmatically assigns the Insurance Verification object to the Accounts Receivable team. Access control logic ensures that only members of the Accounts Receivable team who are also assigned to the originating medical office are permitted to access the verification object. This restriction is enforced using team-office affiliation mappings stored in a permissions database.

At step 606, any authorized user with privileges for the originating medical office may append commentary to the Insurance Verification object. Thus, in some embodiments, and as a part of step 606, the system can receive commentary for appending to the Insurance Verification Object from an authorized user with requisite privileges, and the system 100 can append this commentary to the Insurance Verification Object. In some embodiments, commenting does not alter the team assignment. In some embodiments, all user-generated commentary is appended to an immutable comment log, and system-generated timestamps are attached and stored within a secure, append-only audit trail subsystem.

At step 608, a team in possession of the Insurance Verification may determine that supplemental information is required. The user may enter a structured request for additional information, which request can be received by the system 100. This triggers a system-mediated reassignment of the Insurance Verification to the alternate team. The informational request is stored as a message object and displayed to the alternate team, indicating the need for action. The alternate team may respond by submitting the required information, upon which the Insurance Verification is reassigned back to the requesting team.

At step 610, and upon determining that the verification task is complete, a user from the Accounts Receivable team submits the Insurance Verification for approval. In some embodiments, the system 100 can receive the submission of the Insurance Verification for approval. As part of this submission, the user selects a status designation from predefined categories, such as “Insurance Verification—Passed” or “Insurance Verification—Failed.” This action causes the system to reassign the object to the Office Team and update its status to “pending approval.”

At step 612, the Office Team users retrieve all Insurance Verifications marked as pending approval and perform final validation. The system 100 can receive the final verification of objects marked “pending approval”. Upon successful verification, the Insurance Verification object is transitioned by the system 100 from an active state to a completed state. The object is then removed by the system 100 from active workflow queues and stored in a segregated datastore designated for completed verifications.

In some embodiments, all completed Insurance Verifications remain accessible for post-process auditing. Access can be provided through a secure interface that enforces read-only permissions and displays associated audit trails, including modification timestamps and user interaction logs. In some embodiments, a completed Insurance Verification may be reopened by an authorized user. Reopening triggers a state transition that reinserts the object into the active workflow, preserving all historical metadata and audit logs.

In some embodiments, and to ensure audit integrity, the system 100 enforces strict immutability of communication history and timestamp metadata. No user or service component has the ability to modify or delete these records post-creation. This supports compliance with data governance frameworks such as HIPAA and SOC 2.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method comprising:
receiving login information from the user, the login information comprising at least a password and a time-sensitive email-based security code;
verifying the password using a cryptographic hash function and validating the email-based security code with a time-limited JSON Web Token (JWT);
receiving from a user a request for messages, the request for messages comprising information relating to the user;
retrieving the requested messages from a database;
generating serialized and encrypted data objects from the retrieved messages; and
sending the encrypted data objects to the requesting user.

2. The method of claim 1, wherein the time-limited token is issued at login.

3. The method of claim 1, wherein the information relating to the user comprises at least one of a username, a password, or a unique token.

4. The method of claim 3, wherein the information relating to the user further relates to a location of the user.

5. The method of claim 4, wherein the information relating to the user relates to the location of the user comprises at least one of: an IP address; a MAC address; or the user location.

6. The method of claim 5, wherein generating serialized and encrypted data objects comprises serializing the messages into a structure format.

7. The method of claim 6, wherein generating serialized and encrypted data objects further comprises encrypting the serialized messages using AES-256 encryption, wherein the encryption key is retrieved at runtime from a secure key management service.

8. The method of claim 7, wherein the encrypted data objects are transmitted via a secure transport channel.

9. The method of claim 8, wherein the password is verified using a bcrypt hashing algorithm.

10. The method of claim 9, wherein the JWT is signed using a secret key retrieved dynamically at runtime from a secure key management service.

11. The method of claim 10, wherein the secure key management service is Amazon Web Services (AWS) Secrets Manager.

12. The method of claim 11, wherein the JWT is configured to expire within 24 hours.

13. The method of claim 12, further comprising validating user session freshness by comparing activity timestamps stored in a database and denying access if the session is stale.

14. The method of claim 13, wherein the encrypted data objects are encoded as Base64 strings prior to transmission.

15. The method of claim 14, wherein the serialization of messages is performed using JavaScript Object Notation (JSON).

16. The method of claim 15, further comprising retrieving an environment-specific encryption key from a secure key management service to perform the encryption.

17. The method of claim 16, wherein the transmission of the encrypted data objects to the user is performed via a secure HTTPS communication channel.

18. The method of claim 17, further comprising enforcing multi-factor authentication by requiring a password and a six-digit email-based security code during login.

19. The method of claim 18, further comprising storing encrypted session persistence tokens as httpOnly, secure, and sameSite cookies bound to a specific device fingerprint.

20. The method of claim 19, further comprising: implementing brute-force protection by throttling login attempts according to a multi-step lockout strategy based on failed login attempt counts; and performing role-based access control by populating a user context with authenticated attributes including organization, office, and permission group identifiers to enforce least-privilege policies.
